(19) United States
(12) Patent Application Publication
(10) Pub. No.: US 2024/0044799 A1
(43) Pub. Date: Feb. 8, 2024

(54) PHOTOLUMINESCENCE FOR SEMICONDUCTOR YIELD RELATED APPLICATIONS

(71) Applicant: KLA Corporation, Milpitas, CA (US)

(72) Inventors: James Xu, San Jose, CA (US); David W. Shortt, Los Gatos, CA (US); Yiwu Ding, Danville, CA (US)

(21) Appl. No.: 18/358,841

(22) Filed: Jul. 25, 2023

Related U.S. Application Data
(60) Provisional application No. 63/394,621, filed on Aug. 3, 2022.

(51) Int. Cl. G01N 21/64

(52) U.S. Cl. CPC G01N 21/6489; G01N 21/6456; G01N 21/9501

(57) ABSTRACT

Methods and systems for determining information for a specimen are provided. Certain embodiments relate to detecting photoluminescence for applications such as inspection and/or metrology of electro-optically active devices or advanced packaging devices. One embodiment of a system includes an illumination subsystem configured for directing light having one or more illumination wavelengths to a specimen and a detection subsystem configured for detecting photoluminescence from the specimen. The system also includes a computer subsystem configured for determining information for the specimen from output generated by the detection subsystem responsive to the detected photoluminescence.

### BACKGROUND OF THE INVENTION

### 1. Field of the Invention

The present invention generally relates to methods and systems configured for determining information for a specimen. Certain embodiments relate to detecting photoluminescence for inspection or metrology applications.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on wafers to promote higher yield in the manufacturing process and thus higher profits. Inspection has always been an important part of fabricating semiconductor devices such as ICs. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on the wafer where defects have been detected by inspection. The higher resolution data for the defects generated by defect review is more suitable for determining attributes of the defects such as profile, roughness, more accurate size information, etc.

Metrology processes are also used at various steps during a semiconductor manufacturing process to monitor and control the process. Metrology processes are different than inspection processes in that, unlike inspection processes in which defects are detected on a wafer, metrology processes are used to measure one or more characteristics of the wafer that cannot be determined using currently used inspection tools. For example, metrology processes are used to measure one or more characteristics of a wafer such as a dimension (e.g., line width, thickness, etc.) of features formed on the wafer during a process such that the performance of the process can be determined from the one or more characteristics. In addition, if the one or more characteristics of the wafer are unacceptable (e.g., out of a predetermined range for the characteristic(s)), the measurements of the one or more characteristics of the wafer may be used to alter one or more parameters of the process such that additional wafers manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a wafer may be independent of the results of an inspection process performed on the wafer. In particular, the locations at which a metrology process is performed may be selected independently of inspection results. In addition, since locations on the wafer at which metrology is performed may be selected independently of inspection results, unlike defect review in which the locations on the wafer at which defect review is to be performed cannot be determined until the inspection results for the wafer are generated and available for use, the locations at which the metrology process is performed may be determined before an inspection process has been performed on the wafer.

Different processes such as those described above may be selected based on the information that is to be determined for a specimen, e.g., inspection for when defects are to be detected, review for when detected defects are to be redetected and further examined, metrology for when a characteristic of a specimen is to be measured, etc. Different processes may also be used for different specimens. For example, different inspection processes may be used or needed for different types of semiconductor devices. Different inspection processes may also be used or needed for the same type of semiconductor devices at different points in the fabrication process.

Most of the time, which process is useful for a semiconductor device at any given point in time is obvious. In one such example of obvious processes that are useful for examining electro-optically active devices, electrical test is the traditional method used to determine whether such devices work properly. Electron beam inspection may also be used, for example, in voltage contrast (VC) modes to find shorts or opens. In addition, traditional optical or electrical beam inspection may be used to find many other defect types such as bridges, fall-on particles, etc.

There are plenty of other instances, however, in which an appropriate process for examining a semiconductor specimen at a given point in the fabrication process is not always clear. For example, certain defect types related to material band gap, color uniformity, light emission efficiency, etc. of electro-optically active devices are not easy to detect and measure with traditional inspection and metrology methods because they are hard to correlate with traditional defect types. Traditional techniques can also be relatively slow, and sometimes even so slow that they become impractical. For example, many of the processes described above can negatively impact the semiconductor fabrication process if they take too long. Therefore, methods that can measure light at a substantially high throughput are preferred and often required.

Accordingly, it would be advantageous to develop systems and methods for determining information for semiconductor related specimens such as electro-optically active devices and advanced packaging devices that do not have one or more of the disadvantages described above.

### SUMMARY OF THE INVENTION

The following description of various embodiments is not to be construed in any way as limiting the subject matter of the appended claims.

One embodiment relates to a system configured to determine information for a specimen. The system includes an illumination subsystem configured for directing light having one or more illumination wavelengths to a specimen. The system also includes a detection subsystem configured for detecting photoluminescence (PL) from the specimen. In addition, the system includes a computer subsystem configured for determining information for the specimen from output generated by the detection subsystem responsive to the detected PL. The system may be further configured as described herein.

Another embodiment relates to a method for determining information for a specimen. The method includes directing light having one or more illumination wavelengths to a specimen. The method also includes detecting PL from the specimen. In addition, the method includes determining information for the specimen from output responsive to the detected PL. Each step of the method may be performed as described herein. The method may include any other step(s) of any other method(s) described herein. The method may be performed by any of the systems described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIG. 1 is a schematic diagram illustrating a side view of an embodiment of a system configured as described herein;

FIG. 2 is a schematic diagram illustrating different types of images that may be generated for a specimen described herein;

FIG. 3 is a schematic diagram illustrating an example of a more detailed image of one of the anomalous regions shown in one of the images of FIG. 2;

FIG. 4 is a schematic diagram illustrating a plan view of an example of different regions of devices on a specimen and embodiments of composite images that may be generated for the different regions by the embodiments described herein;

FIG. 5 is a plot of an example of photoluminescence (PL) emission spectra of single micro-light emitting diodes (LEDs) showing differences between the spectra of normal and anomalous pixels;

FIG. 6 is a schematic diagram illustrating an example of an image of green-emitting devices with defects of varying colors;

FIG. 7 is a schematic diagram illustrating an example of an image of blue-emitting devices with regions of varying sizes, brightness, and colors;

FIG. 8 is a plot of an example of PL emission spectra under different excitation wavelengths; and

FIG. 9 is a block diagram illustrating one embodiment of a non-transitory computer-readable medium storing program instructions for causing one or more computer systems to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein relate to methods and systems for determining information for a specimen using photoluminescence (PL) detected from the specimen. The embodiments described herein may be configured for using various illumination and collection wavelength bands and modes of a multi-wavelength inspection system, which may be a commercially available system such as the Altair system commercially available from KLA Corp., Milpitas, Calif., which may be tailored as described herein to take advantage of material and device properties of the specimen, to perform a substantially fast inspection over a substantially wide area (e.g., full dice or even a whole wafer), and to analyze the PL signals to identify defects or regions of abnormal behavior. Such defects may be difficult to detect, or invisible, with traditional optical inspection, but configuring the systems for detecting PL allows the systems to reveal additional defect types at substantially high throughput. In a similar manner, the embodiments described herein may be configured for metrology processes or systems configured for determining one or more metrological characteristics of the specimen.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens and/or specimens related to the fabrication of semiconductor devices.

“Photoluminescence” or PL is defined herein as light emission from any form of matter after the absorption of photons (electromagnetic radiation). In other words, PL is a phenomenon that may occur when light stimulates the emission of a photon. There are multiple types of PL including fluorescence, phosphorescence, and chemiluminescence. Fluorescence occurs when photons excite a molecule raising it to an electronic excited state. The type of PL that the embodiments described herein are configured for detecting will vary depending on the specimen and the materials formed thereon.

Some molecules that may be present on the specimens described herein may emit PL such as fluorescence in response to illumination by the embodiments described herein. For example, for PL to occur, an electron from a lower energy level has to be excited to an upper energy level via absorption of an excitation photon. Subsequently, the electron relaxes to a lower energy level via emission of a PL photon. In a molecule, electron transition occurs between discrete energy levels.

Such materials may include organic or non-device materials like photoresists that are purposefully formed on the specimens at some fabrication process steps in addition to other foreign materials like fall-on particles that are never intentionally formed on the specimens described herein. The fluorescence of such materials is for the purposes described herein unrelated to the function of the materials. For example, photoresists are designed to change chemically in response to exposure of the photoresists to some electromagnetic energy so that they can be patterned and then used to transfer that pattern to other material(s) on the specimen. However, the materials themselves in their normal functionality do not emit light.

In one embodiment, the specimen includes one or more packaging structures formed thereon. For example, in advanced semiconductor packaging fabrication processes, polymer-based materials such as polimide (PI) and polybenzoxazole (PBO) are often used as intermetal dielectrics. In these materials, PL takes on one of its several forms called fluorescence where a molecule is excited by an illumination photon and then relaxes to a lower energy state through emission of a photon without a change in electron spin. Since polymers emit fluorescence while metals do not, it is possible to use PL inspection to enhance the capture rate of certain hard-to-find defects. Like the materials described above, the fluorescence or other PL emitted by such materials in response to llumination by the systems described herein and detected by the systems described herein is unrelated to the normal functionality of the materials. For example, a dielectric material such as those described above in its normal functionality does not emit light of any kind.

In terms of the embodiments described herein, “advanced packaging devices” mean that part or all of the packaging of the devices is performed while the devices are still in wafer form themselves or attaching/bonding to devices in wafer form. In addition, an “advanced packaging process” usually involves processing techniques similar to those used in making semiconductor devices on wafers (e.g., multi-layer thin film processes, chemical-mechanical polishing (CMP), etc.). While the embodiments described herein may be particularly suitable for such devices, the embodiments are also suitable for determining information for other types of packaging or packaged devices in addition to unpackaged semiconductor devices.

In contrast, the designed functionality of some devices formed on the specimens described herein may be what causes PL that is detected and used by the embodiments described herein. For example, in a semiconductor, the atoms may form a periodic crystal structure, and PL may occur when an electron from a lower energy band is excited to an upper energy band due to absorption of an excitation photon and thereafter relaxes to the lower energy band via emission of a PL photon. The different energy bands may be, for example, conduction and valence bands. So, electron transition may occur between valence and conduction bands. In this manner, if some electro-optically active devices are illuminated with one or more carefully selected wavelengths, the electro-optically active devices may emit PL as they would emit light when they are functioning properly. Therefore, such PL is related to the electrical functioning that the devices are designed for.

In one embodiment, the specimen includes electro-optically active devices. In a further such embodiment, the electro-optically active devices include micro-light emitting diodes (LEDs), and the PL includes PL emitted by the micro-LEDs. (A “micro-LED” as that term is used herein is defined as an LED that is smaller than 100 microns in size.) For example, one important new feature of the embodiments described herein is that they provide systems capable of exciting and analyzing PL emission of micro-LEDs. In the case of certain electro-optically active semiconductor devices such as micro-LEDs, quantum dots, integrated photonics, etc., it is possible for absorbed photons to excite quantum states not dissimilar to the states normally achieved by currents of electrons or holes during designed operation of the devices. In one example, the PL emitted by blue-emitting devices would be blue, the PL emitted by green-emitting devices would be green, and so on. Therefore, it is possible to probe electro-optical properties of the devices using PL. Such PL may also be observed, detected, and used as described herein even if the devices are not yet completed and therefore are non-functional in their intended final form.

As described further herein, one important advantage of the embodiments described herein is their flexibility. For example, in some embodiments, the PL does not include fluorescence. In another embodiment, the PL includes fluorescence. In other words, the type of PL that is detected and then used for determining information for the specimen may include any of the types of PL described above, including multiple types at the same time. In one such example, due to the cost and complexity of the systems described herein, it is extremely advantageous when the same tool can be used for different specimens and/or determining different kinds of information for the same types of specimens or even different types of specimens. If a system can be used to detect fluorescence from materials such as foreign particulates and others described above and can also be used to detect PL from at least partially formed electro-optically active devices, that can be extremely beneficial to the system owner.

The flexibility of the embodiments described herein is not limited to just different types of PL. For example, the embodiments described herein may be flexibly configured to detect only PL, a combination of PL and non-PL light, scattered light and/or reflected light, etc. One or more types of such light may be detected simultaneously or sequentially as described further herein. In addition, information for a specimen may be determined from any one or more of types of such detected light. In other words, the same system may be configured for determining multiple types of information from one or more types of detected light. Whether different types of light are detected from a specimen will depend on the specimen characteristics and the information to be determined, and whether the different types of light can be detected simultaneously from the specimen may vary depending on such factors including, but not limited to, differences in signal levels between specimens, emission spectra wavelength range of emitted light, etc.

Another possible use for the embodiments described herein is detecting different PL for the same purpose. For example, the systems described herein may be used for detecting different types of defects on a specimen, some of which emit PL at different wavelengths and/or one or more of which emit PL while others do not (meaning that they would have to be detected at the same wavelength(s) as the illumination). In such cases, the systems described herein may be configured for separately detecting the different kinds of light and therefore the different kinds of defects simultaneously or sequentially in the same manners described above.

Another important distinction between the embodiments described herein and what may be other currently available systems and methods for detecting PL from a specimen is that the embodiments described herein can examine the specimens described herein at throughputs that can compete with that of currently used semiconductor yield-related tools such as wafer inspection tools designed for production-worthy throughputs. In other words, the embodiments described herein are or can be configured for detecting PL and determining information from the PL as fast as any other inspection tools currently on the market for semiconductor applications. One reason why achieving such throughput in the embodiments described herein is particularly difficult and may necessitate careful selection of the system configuration is that the amount of light that is available for detection will most likely be much less than that in currently available systems. For example, the amount of PL light that is emitted from the specimens described herein may be substantially small compared to the amount of non-PL light that is scattered or reflected from most of these specimens. More specifically, PL quantum yield is less than 1, and PL light emits isotopically and therefore collected partially by an objective lens with limited numerical aperture (NA). Therefore, detecting as much of the PL as possible in as short an amount of time as possible becomes even more critical for configuring systems that can be used for PL related applications without having detrimental effects on the throughput of the overall process.

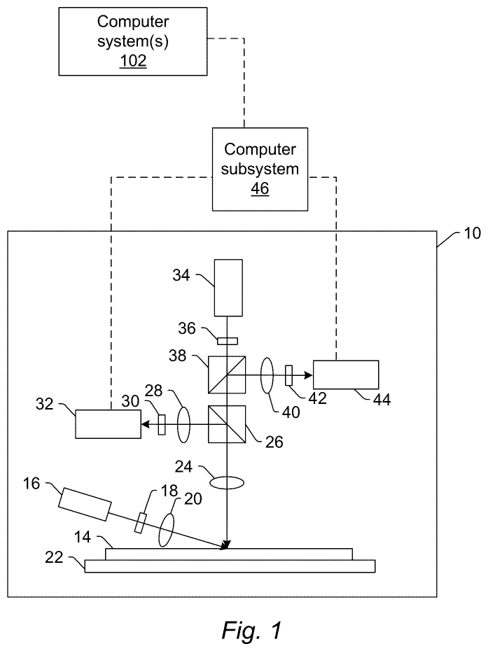

One embodiment of a system configured for determining information for a specimen is shown in FIG. 1. The system includes an illumination subsystem configured for directing light having one or more illumination wavelengths to a specimen. The illumination subsystem includes at least one light source such as light source 16 and/or light source 34. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen. The light from light source 34 may be directed through optical element 36, beamsplitters 38 and 26, and then lens 24 to specimen 14 at a normal (or substantially normal) angle of incidence. If the angle at which light from light source 34 is directed to the specimen is not exactly normal, the substantially normal angle of incidence may be selected based on characteristics of the specimen.

The illumination subsystem may be configured to direct the light to the specimen at different angles of incidence at different times. For example, the illumination subsystem may be configured to direct light from one light source to the specimen and then to direct light from the other light source to the specimen. The illumination subsystem may also or alternatively be configured to direct light to the specimen at more than one angle of incidence at the same time. For example, the illumination subsystem may include more than one illumination channel, one of the illumination channels may include light source 16, optical element 18, and lens 20 and another of the illumination channels may include light source 34, optical element 36, and lens 24. If light from multiple illumination channels is directed to the specimen at the same time, one or more characteristics (e.g., wavelength, polarization, etc.) of the light directed to the specimen at different angles of incidence may be different such that light resulting from illumination of the specimen at the different angles of incidence can be separated from each other and separately detected at the detector(s).

The same illumination channel may also be configured to direct light to the specimen with different characteristics at different times. For example, in some instances, optical elements 18 and 36 may be configured as spectral filters and the properties of the spectral filters can be changed in a variety of different ways (e.g., by swapping out the spectral filters) such that different wavelengths of light can be directed to the specimen at different times. The illumination subsystem may have any other suitable configuration known in the art for directing the light having different or the same characteristics to the specimen at different or the same angles of incidence sequentially or simultaneously.

In one embodiment, light sources 16 and 34 may each include a broadband plasma (BBP) light source. In this manner, the light generated by the light sources and directed to the specimen may include broadband light. However, the light sources may include any other suitable light sources such any suitable lasers, arc lamps, multiple color LEDs, etc. known in the art configured to generate light at any suitable wavelength(s) known in the art. The light sources may be configured to generate light that is monochromatic or nearly-monochromatic. In this manner, the light sources may be narrowband light sources. The light sources may also include polychromatic light sources that generate light at multiple discrete wavelengths or wavebands. Light sources 16 and 34 may also be the same type of light sources, possibly with one or more different light emitting characteristics (e.g., lasers that emit different wavelengths), or different types of light sources (e.g., one light source may be a BBP light source and the other light source may be a laser). In addition, the illumination subsystem may include a different number of light sources, e.g., one or more light sources, and the light source(s) that are used to direct light to the specimen may vary, as described further herein, depending on the specimen and the information being determined for it.

An optimum wavelength range for the illumination subsystem may depend on achievable light budget vs. throughput and sensitivity requirements. In one embodiment, the one or more illumination wavelengths include red (R), green (G), blue (B), and ultraviolet (UV) wavelengths. For example, to enable the functionality described herein, UV illumination may be added to the bright field (BF) and/or dark field (DF) modes in an existing R/G/B BF and/or DF illumination subsystem. The UV wavelength(s) may be in the wavelength range between about 360 nm and about 405 nm. In some embodiments, a broadband light source that generates light at wavelengths from 360 nm to 720 nm may be used, and one or more filters may be positioned in front of the light source depending on the specimen being examined. For example, if only UV light is being used for a specimen, optical element 18 may in some cases be a bandpass filter configured for 385 nm±13 nm. An illumination band-pass filter may not always be used and may not be as essential to the configurations described herein as other possible filters, e.g., long-pass filter(s) in the detection subsystem. However, it may be important to use a band-pass filter in the illumination for some specimens with or without the long-pass filter in the detection subsystem. For example, even with a color LED light source, there can be a long tail of illumination wavelengths, which may interfere with detecting the light with a sufficient signal-to-noise ratio. In addition, PL signals can be substantially weak under even the best conditions so any leakage of illumination light into the detection subsystem can overwhelm those signals.

In some embodiments, the specimen includes electro-optically active devices, and the one or more illumination wavelengths are selected to be absorbable by the electro-optically active devices to emit the PL. Experimental data generated by the inventors indicated that in order to excite PL emission for blue-emitting devices, UV illumination is usually needed. To excite green-emitting devices, it may be possible to use either UV or blue illumination, or a combination thereof. To excite red-emitting devices, it may be possible to use UV, blue or green illumination, or a combination. It may be important to provide choice in this regard in order to optimize sensitivity and light budget.

In one embodiment, the one or more illumination wavelengths include R, G, and B wavelengths. For example, data generated by the inventors shows that blue or even green illumination is sufficient to excite some green- or red-emitting devices, respectively. Therefore, one possible configuration of a system would not include UV illumination, but rather rely on the existing B, G, and R illumination in commercially available systems such as Altair. Such a system would not be able to inspect blue-emitting devices in the same way, e.g., using PL emitted from the devices, but this may be an acceptable trade-off in some circumstances. Such a system would be less complex and cost less than a full R/G/B/UV PL system. In this manner, one important new feature of the embodiments described herein is that they can be configured as an R/G/B or R/G/B/UV system optimized for electro-optically active devices and/or for advanced packaging devices.

Light from optical element 18 may be focused onto specimen 14 by lens 20, and light from optical element 36 may be focused onto specimen 14 by lens 24. Although lenses 20 and 24 are shown in FIG. 1 as single refractive optical elements, in practice, lenses 20 and 24 may each include a number of refractive and/or reflective optical elements that in combination focus the light from their respective optical elements to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more of the elements of the illumination subsystem based on the type of illumination to be used for determining information for the specimen.

The system may also include a scanning subsystem configured to cause the light to be scanned over the specimen. For example, the scanning subsystem may include stage 22 on which specimen 14 is disposed during the process. The scanning subsystem may include any suitable mechanical and/or robotic assembly (that includes stage 22) that can be configured to move the specimen such that the light can be scanned over the specimen. In addition, or alternatively, the system may be configured such that one or more optical elements perform some scanning of the light over the specimen. The light may be scanned over the specimen in any suitable fashion such as in a serpentine-like path or in a spiral path.

In one embodiment, the scanning subsystem is configured for causing the light from the illumination subsystem to be scanned over the specimen while the PL is detected from the specimen at an inline inspection throughput. For example, one important new feature of the embodiments described herein is that they are capable of performing PL inspection at a high enough throughput to be suitable for inline inspection, meaning inspection performed during a semiconductor fabrication process or between fabrication process steps. In this manner, the throughput achievable by the embodiments described herein may be equivalent to what is sometimes referred to in the art as a “production worthy throughput.” The embodiments described herein may be capable of achieving different throughputs depending on the emitted light that is being detected for a specimen. The embodiments are advantageously capable of achieving an inline inspection throughput for electro-optically active devices such as micro-LEDs of about several wafers per hour (300 mm wafer equivalents). Therefore, an “inline inspection throughput” as that term is used herein for inspection of electro-optically active devices can be defined as 2-10 300 mm wafer equivalents per hour.

The term “wafer equivalents” is used here to make the throughput of the system embodiments easily comparable to the other types of wafer inspection. For example, currently a large percentage of micro-LEDS are fabricated on 6-inch sapphire wafer substrates. Some manufacturers are experimenting on using 8-inch and 12-inch silicon wafers to fabricate micro-LEDs. The embodiments described herein may therefore be used to inspect such differently sized specimens, and the throughput will therefore vary accordingly. So to provide a PL inspection throughput estimate of the embodiments described herein, we use “300 mm equivalents” as a qualifier. If the embodiments described herein are used to inspect 6-inch sapphire wafers, then the throughput estimate will be in the upper teens (e.g., close to 20 wafers per hour).

The system also includes a detection subsystem configured for detecting PL from the specimen. The detection subsystem may include one or more detection channels. In general, each of the detection channels includes a detector configured to detect light from the specimen due to illumination of the specimen by the illumination subsystem and to generate output responsive to the detected light. For example, the detection subsystem shown in FIG. 1 includes two detection channels, one formed by lens 24, beamsplitter 26, lens 28, element 30, and detector 32 and another formed by lens 24, beamsplitter 38, lens 40, element 42, and detector 44. The two detection channels may be configured to collect and detect light at different or the same angles of collection. In some instances, the detection channel that includes detector 32 is configured to detect light scattered from the specimen due to illumination with light from light source 16, and the detection channel that includes detector 44 is configured to detect light specularly reflected from the specimen due to illumination with light from light source 34. Therefore, the detection channel that includes detector 32 may be configured as a dark field (DF) channel, and the detection channel that includes detector 44 may be configured as a bright field (BF) channel. In other instances, as described further herein, the detection subsystem may be configured to detect only DF light or only BF light.

Although FIG. 1 shows an embodiment of the detection subsystem that includes two detection channels, the detection subsystem may include a different number of detection channels (e.g., only one detection channel or two or more detection channels). In one such instance, the detection subsystem may include one or more DF channels and/or one or more BF channels. Therefore, the detection subsystems described herein may be configured for only DF, only BF, or both DF and BF imaging (simultaneous or sequential).

In one embodiment, the illumination and detection subsystems are configured for both BF and DF imaging, and the computer subsystem, e.g., computer subsystem 46, is configured for selecting only the BF imaging, only the DL imaging, or both the BF and DF imaging for determining the information based on one or more characteristics of the specimen. Therefore, the embodiments described herein provide systems that have BF/DF flexibility in addition to the other important flexibilities described herein. In this manner, one new important feature of the embodiments described herein is that they are flexible BF/DF systems with multiple illumination and collection bands and modes for PL inspection and/or metrology.

The one or more characteristics of the specimen may include any known or expected characteristics of the specimen such as whether the defects of interest (DOIs) scatter more light than they reflect, which angles electro-optically activated devices are expected to emit light into, height or side-wall angle of structures on the specimens which can affect whether scattered or reflected light is better for imaging, etc. The type of imaging and other mode considerations may also take into consideration both specimen characteristics that are of interest, e.g., defects that are expected to scatter light, as well as specimen characteristics that affect the light from the specimen but are not of interest, e.g., strong reflection from structure edges. In this manner, the configuration of the systems described herein used for determining the information for the specimen may be selected to both selectively detect certain light while also avoiding or at least reducing detection of other light, which is why the flexibility described herein is substantially important.

Although lenses 28 and 40 are shown in FIG. 1 as single refractive optical elements, each of the lenses may include one or more refractive optical element(s) and/or one or more reflective optical element(s). Beam splitters 26 and 38 may have any suitable configuration known in the art. As shown in FIG. 1, lens 24 may be configured 1) to direct light from light source 34 to the specimen and 2) to collect a) light scattered from the specimen due to illumination with light from light source 16 and b) light specularly reflected from the specimen due to illumination with light from light source 34. Therefore, the detection channels may share a common lens. However, the detection channels may not share any common elements or may share more than one common element (not shown; e.g., like a common spectral filter). Elements 30 and 42 may each include any one or more suitable elements known in the art such as apertures, spatial filters, analyzers, other polarizing elements or filters, spectral filters, and the like. In addition, although only one element is shown positioned in the path of the light to each of the detectors, more than one such element may be used in each detection channel (such as a combination of a spectral filter and a spatial filter). Furthermore, in one or both detection channels, the positions of lens 28 and element 30 and the positions of lens 40 and element 42 may be switched so that the light passes through the elements and then the lenses.

In one embodiment, the detection subsystem includes a long-pass filter, e.g., element 30 and/or element 42, positioned in front of a detector configured for detecting the PL. Since most PL phenomena involve light emitted at longer wavelengths than the excitation light, long-pass wavelength filters may be included in the collection path to block shorter wavelengths and pass longer ones. For example, the detection subsystem may include a UV-blocking filter that blocks essentially all of the UV illuminating band while passing essentially all of the B, G, and R bands. In one such example, the long-pass filter may be a 425 nm long-pass filter. A UV/B blocking filter would block essentially all of the UV and blue bands while passing essentially all of the green and red bands. And a UV/B/G blocking filter will block essentially all of the UV, blue, and green bands while passing essentially all of the red band.

There may also be multiple filters in the path of the collected/detected light. In addition or alternatively, beamsplitter 26 and/or beamsplitter 38 may be configured for performing some wavelength based filtering of the light collected by lens 24. To generate color PL images, the detection subsystem may also include wavelength filters in the collection path that only pass a particular band: UV, B, G, or R. In some cases, the illumination subsystem may include a band-pass filter in the illumination path to prevent any illumination light leaking into the collection path.

Configuring the system with a combination of the filters and illumination wavelengths described further herein enables the system to have great flexibility to cover a wide range of PL phenomena. In one embodiment, the illumination subsystem is configured for directing light having multiple illumination bands to the specimen, the detection subsystem is configured for detecting light having multiple detection bands from the specimen, and the computer subsystem is configured for selecting one or more of the multiple illumination bands and one or more of the multiple detection bands used for determining the information based on one or more characteristics of the specimen. The computer subsystem may be configured for selecting the illumination band(s) and the detection band(s) as described further herein. In operation, the computer subsystem may generate a recipe that specifies the specific PL bands and modes to be used for a particular specimen. If needed, multiple scans can be performed to collect the required image data.

Several levels of hardware implementation are possible for the system embodiments described herein, ranging from relatively simple with fewer features and capability, to more complex with more capability. In one such example, the computer subsystem may generate a recipe for detecting PL resulting from blue illumination in an existing R/G/B system by adding a long-pass PL filter on the collection optics. This configuration would likely not be able to inspect blue-emitting devices, but could inspect green- or red-emitting devices. In another example, the computer subsystem may add UV illumination in an outside-the-lens (OTL) DF mode, coupled with a long-pass PL filter on the R/G/B collection optics. In this case, both blue and/or UV illumination could be used. In a further example, the system may be configured by adding UV through-the-lens (TTL) optics in addition to UV OTL illumination to an existing R/G/B BF/DF capable system, coupled with a long-pass PL filter. This configuration gives the most capability.

Lenses 20 and 24 are shown in FIG. 1 as different optical elements. In this case, the illumination channel that includes light source 34 and the detection channel(s) that detect light responsive to illumination by that illumination channel are configured as TTL optics. The illumination channel that includes light source 16 and the detection channel(s) that detect light responsive to illumination by that illumination channel are configured as OTL optics. However, in some configurations, lenses 20 and 24 may be the same optical element or elements (not shown). In such instances then, all of the illumination and detection channels may be configured as TTL optics. However, the illumination subsystem may be further configured so that all of the illumination channels are configured for OTL illumination (not shown). In such instances, the illumination channel that includes light source 34 may include a lens that directs light to the specimen, which may be lens 20 or another separate lens (not shown), positioned out of the path of the light collected and detected from the specimen. In any case, light from light sources 16 and 34 may be directed to the specimen at different angles of incidence.

Another possibly attractive configuration for some of the specimens described herein is a DF configuration with UV and/or blue illumination. In such a configuration, the illumination may be symmetrical illumination about the plane of incidence. For example, two-sided illumination, double or full illumination, or ring illumination may be used in the embodiments described herein to eliminate edge shadows in the specimen images generated by the system. Such illumination may be most practical in an OTL configuration. As can be seen from the configuration descriptions, therefore, there are a substantially large number of optical modes that can be used in the embodiments described herein due to the flexible illumination and flexible collection/detection subsystems described herein. In another such example, asymmetric illumination may be more suitable for some specimens than symmetric illumination, and the embodiments described herein can be configured for such illumination.

The one or more detection channels may include any suitable detectors known in the art such as photo-multiplier tubes (PMTs), charge coupled devices (CCDs), and time delay integration (TDI) cameras. The detectors may also be capable of detecting one or more wavelength ranges described herein such as UV and/or visible. One example of a suitable detector is a color CCD camera. In one embodiment, one or more of the detection channels include a spectrometer configured for measuring the spectrum of emitted light. The spectrometer may have any suitable configuration known in the art. Data collected by the inventors and described further herein has shown subtle spectral shifts among devices that can be of diagnostic use.

The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels may be signals or data, but not image signals or image data. In such instances, a computer subsystem such as computer subsystem 46 may be configured to generate images of the specimen from the non-imaging output of the detectors. However, in other instances, the detectors may be configured as imaging detectors that are configured to generate image signals or image data. Therefore, the system may be configured to generate images in a number of ways.

The computer subsystem, e.g., computer subsystem 46, may also include image acquisition software configured for collecting images under various appropriate illumination and collection wavelength bands. Depending on the optics configuration, multiple scans may be used to acquire all the desired data.

FIG. 1 is provided herein to generally illustrate a variety of configurations of illumination and detection subsystems that may be included in the system embodiments described herein. Obviously, the system configurations described herein may be altered to optimize the performance of the system as is normally performed when designing a commercial system. In addition, the systems described herein may be implemented using an existing system (e.g., by adding functionality described herein to an existing system) such as the Altair and 29xx/39xx series of tools that are commercially available from KLA. For some such systems, the embodiments described herein may be provided as optional functionality of the system (e.g., in addition to other functionality of the system). Alternatively, the system described herein may be designed “from scratch” to provide a completely new system.

In one such example, the embodiments described herein can be applied in a relatively straightforward manner to some tools that already offer a wide range of illumination wavelengths, e.g., via a BBP light source. In such instances, PL filters may be added to the tools as described above in addition to any appropriate image acquisition capability, e.g., via software and/or algorithms implemented on the computer subsystem.

In another example, PL emission is isotropic regardless of illumination direction. Therefore, PL detection may be implemented on currently used platforms including DF platforms without breaking the current architectures. In one such example, a compact, external near ultraviolet (NUV) DF illuminator may be added to some architectures below the optics plate. In addition, a long-pass filter may be easily added in front of a detector.

The embodiments described herein may also be implemented by augmenting a blue LED enabled inspection tool so that it has PL detection capability described herein. The embodiments may also be implemented by modifying an existing system to thereby enable PL inspection of blue LED wafers and increase PL inspection throughput.

The illumination and detection subsystems may be further configured as described in U.S. Pat. No. 7,782,452 issued Aug. 24, 2010 to Mehanian et al. and U.S. Pat. No. 8,218,221 issued Jul. 10, 2012 to Solarz and U.S. Patent Application Publication No. 2009/0059215 published Mar. 5, 2009 by Mehanian et al., which are incorporated by reference as if fully set forth herein. The embodiments described herein may be further configured as described in these references.

Computer subsystem 46 may be coupled to the detectors of the detection subsystem in any suitable manner (e.g., via one or more transmission media, which may include “wired” and/or “wireless” transmission media) such that the computer subsystem can receive the output generated by the detectors during illumination and possibly scanning of the specimen. Computer subsystem 46 may be configured to perform a number of functions described further herein using the output of the detectors.

The computer subsystem shown in FIG. 1 (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer subsystem, then the different computer subsystems may be coupled to each other such that images, data, information, instructions, etc. can be sent between the computer subsystems. For example, computer subsystem 46 may be coupled to computer system(s) 102 as shown by the dashed line in FIG. 1 by any suitable transmission media, which may include any suitable wired and/or wireless transmission media known in the art. Two or more of such computer subsystems may also be effectively coupled by a shared computer-readable storage medium (not shown).

As described further herein, the illumination and detection subsystems may be configured for generating output, e.g., images, of the specimen with multiple modes. In general, a “mode” is defined by the values of parameters of the illumination and detection subsystems used for generating output for a specimen. Therefore, modes may be different in the values for at least one of the parameters of the illumination and detection subsystems (other than position on the specimen at which the output is generated). For example, in an optical subsystem, different modes may use different wavelength(s) of light for illumination. The modes may be different in the illumination wavelength(s) as described further herein (e.g., by using different light sources, different spectral filters, etc. for different modes). In another example, different modes may use different illumination channels of the illumination subsystem. For example, as noted above, the illumination subsystem may include more than one illumination channel. As such, different illumination channels may be used for different modes. The modes may also or alternatively be different in one or more collection/detection parameters of the detection subsystem. The modes may be different in any one or more alterable parameters (e.g., illumination polarization(s), angle(s), wavelength(s), etc., detection polarization(s), angle(s), wavelength(s), etc.) of the system. The illumination and detection subsystems may be configured to scan the specimen with the different modes in the same scan or different scans, e.g., depending on the capability of using multiple modes to scan the specimen at the same time.

The systems described herein and shown in FIG. 1 may be modified in one or more parameters to provide different capability depending on the application for which they will be used. In one embodiment, the system is configured as an inspection system. In another embodiment, the system is configured as a metrology system. For example, the illumination and detection subsystems shown in FIG. 1 may be configured to have a higher resolution if they are to be used for metrology rather than for inspection. In another example, the systems may be configured for performing different scanning methods for inspection versus metrology. In other words, the embodiments of the system shown in FIG. 1 describe various configurations for the system that can be tailored in a number of manners that will be obvious to one skilled in the art to produce systems having different capabilities that are more or less suitable for different applications.

In some embodiments in which the system is configured as an inspection system, the inspection system is configured for macro inspection. In this manner, the systems described herein may be referred to as a macro inspection tool. A macro inspection tool is particularly suitable for inspection of relatively noisy back end of line (BEOL) layers such as redistribution line (RDL) and post-dice applications. A macro inspection tool is defined herein as a system that is not necessarily diffraction limited and has a spatial resolution of about 200 nm to about 2.0 microns and above. Such spatial resolution means that the smallest defects that such systems can detect have dimensions of greater than about 200 nm, which is much larger than the smallest defects that the most advanced inspection tools on the market today can detect, hence the “macro” inspector designation. Such systems tend to utilize longer wavelengths of light (e.g., about 500 nm to about 700 nm) compared to the most advanced inspection tools on the market today. These systems may be used when the DOIs have relatively large sizes.

As noted above, the system may be configured for scanning light over a physical version of the specimen thereby generating output for the physical version of the specimen. In this manner, the system may be configured as an “actual” system, rather than a “virtual” system. However, a storage medium (not shown) and computer system(s) 102 shown in FIG. 1 may be configured as a “virtual” system. In particular, the storage medium and the computer system(s) may be configured as a “virtual” inspection system as described in commonly assigned U.S. Pat. No. 8,126,255 issued on Feb. 28, 2012 to Bhaskar et al. and U.S. Pat. No. 9,222,895 issued on Dec. 29, 2015 to Duffy et al., both of which are incorporated by reference as if fully set forth herein. The embodiments described herein may be further configured as described in these patents.

The computer subsystem, e.g., computer subsystem 46 and/or computer system(s) 102, is configured for determining information for the specimen from output generated by the detection subsystem responsive to the detected PL. In general, the information that is determined by the computer subsystem based on the detection subsystem output may be any inspection- and/or metrology-like information such as that described herein. In addition, the information that is determined for the specimen based on the detection subsystem output may be a combination of multiple types of information described herein.

The computer subsystem may be configured for analyzing the PL responsive output and extracting device and/or defect information from the images. Important PL information for both individual devices or specimen regions containing multiple devices includes, but is not limited to: (1) absolute emitted intensity; (2) intensity emitted into different wavelength bands; (3) relative changes in intensity emitted into different bands (i.e., color shifts); (4) absolute or relative spectra; (5) relative changes in intensity emitted into different cone angles; (6) intensity variation as a function of illumination light level (the leakage effect); and (7) relative changes in intensity among different materials within an image.

In one such example, FIG. 5 is a plot of PL emission spectra for one abnormal micro-LED, i.e., the “dark pixel,” and a normal micro-LED, i.e., the “normal pixel.” As shown by the plotted emission spectra in FIG. 5, the emission spectra of abnormal and normal micro-LEDs are sufficiently different from each other that they can be used to reveal differences in material and/or structure. In other words, by comparing the emission spectra of micro-LEDs to each other, differences between the micro-LEDs can be detected. In addition, comparing the emission spectra of micro-LEDs to the emission spectra of a known “good” micro-LED (a “reference” spectra) can be used to detect abnormal micro-LEDs. In either case, the differences between only some portion of the spectra may be used for the applications described herein. For example, if there is a strong difference between the spectra at longer wavelengths, which is the case in the emission spectra shown in FIG. 5, that difference may be used by the embodiments described herein even if there are other differences between the spectra (such as the shift in the wavelength of the peak emission intensity from 522.26 nm to 518.73 nm). Therefore, by configuring the illumination and detection subsystems as described herein so that they can detect and generate output responsive to the emission spectra of micro-LEDs and by configuring the computer subsystem as described herein to compare the emission spectra to each other or a known good reference, information about the micro-LEDS such as which micro-LEDS are defective in material and/or structure can be determined without having to electrically test the completed micro-LEDs.

The computer subsystem may also or alternatively be configured for analyzing a PL macro-overview image (MOI) of an entire specimen or wafer. The computer subsystem may generate the MOI by stitching multiple PL images together based on various spatial relationships between the individual images. Important PL information for the entire wafer that may be generated by the computer subsystem includes, but is not limited to: (1) intensity variation across the wafer; (2) emission spectra variation across the wafer; (3) emission cone angle variation across the wafer; (4) intensity variation among different wafers, especially among those from the same batch of an epitaxy process; (5) emission spectra variation among different wafers, especially among those from the same batch of an epitaxy process; and (6) emission cone angle variation among different wafers, especially among those from the same batch of an epitaxy process.

In one embodiment, determining the information includes detecting defects on the specimen based on the output generated by the detection subsystem responsive to the detected PL. In this manner, the embodiments described herein may be configured for defect detection using PL techniques. For example, defect detection may be performed using any of the information described above. The defect detection may be performed using either absolute values or relative comparisons (e.g., device-to-device, region-to-region, etc.). In one such example, the computer subsystem may compare an absolute emitted intensity for each device to a threshold (or thresholds), which may correspond to a range of absolute emitted intensities below (and possibly above) the nominal or designed absolute emitted intensity that are unacceptable for the device. If a device has an absolute emitted intensity that is lower or higher than acceptable, it can be detected by the computer subsystem via such comparisons. Other algorithms and methods may also be used for determining which of the devices are defective (such as finding devices that have outlying absolute emitted intensities compared to other devices on the specimen, etc.). In addition, the embodiments described herein may use any suitable defect detection algorithms known in the art that can be applied to the PL responsive output (image or otherwise) or can be modified to operate on the PL responsive output and produce information such as defect maps, heat maps, or any other suitable defect-related information for the specimen.

In one such embodiment, determining the information includes determining a characteristic of functionality of the electro-optically active devices. The characteristic of the functionality may simply be an indication of whether the devices function at all, i.e., emit some light and therefore appear functional or emit no light at all and therefore appear non-functional. However, the characteristic of the functionality may be qualitative or quantitative in one or more additional or other ways. One example of these qualitative characteristics may be whether the devices emit the correct wavelengths of light. Quantitatively, these characteristics may include how different the wavelength of the emitted light is from the desired or expected wavelength of light, differences in brightness between emitted and expected light, and other quantitative measures of the emitted light described further herein. The characteristic of the functionality may be determined for any or all of the devices that are examined by the embodiments described herein and may be used as described further herein for determining which of the devices are defective.

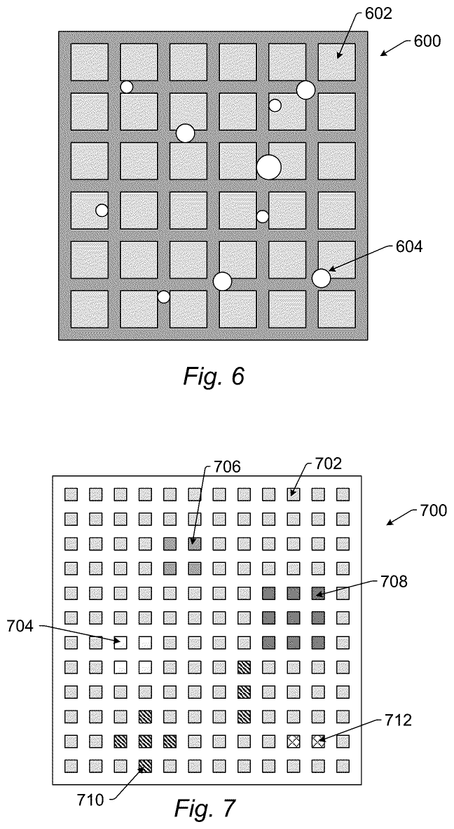

FIGS. 6 and 7 illustrate how color shifts detectable using PL responsive output generated as described herein can be used to detect color shifts and/or variation among devices. In particular, FIG. 6 shows an image of specimen 600 having multiple green-emitting devices 602 formed thereon that may be generated by the embodiments described herein. More specifically, the image shown in FIG. 6 may be generated by illuminating the green-emitting devices with one or more UV illumination wavelengths and detecting the PL (and possibly other light) emitted by the devices. The computer subsystem may then perform defect detection using this image, e.g., by detecting any areas in the image that have emitted different than expected wavelengths of light. Defects 604 show some example defects that may be detected for such green-emitting devices, which may include defects of various sizes and defects that emit yellow light or light green light (e.g., green light that is out of the expected or acceptable green wavelength range). Therefore, the embodiments described herein can detect defects of varying characteristics on green-emitting devices by illuminating the devices with UV light and detecting color shifts in the resulting detected PL.

FIG. 7 shows an image of specimen 700 having multiple blue-emitting devices 702 formed thereon that may be generated by the embodiments described herein. More specifically, the image shown in FIG. 7 may be generated by illuminating the blue-emitting devices with one or more UV illumination wavelengths and detecting the PL (and possibly other light) emitted by the devices. The computer subsystem may then perform defect detection using this image, e.g., by detecting any areas in the image that have emitted different than expected wavelengths of light, any areas that have varying sizes, and/or any areas that have emitted a different than expected brightness of the expected wavelength of light. For example, the shading of the majority of devices 702 indicates devices that are determined to have normal (or acceptable) size, brightness, and color. The devices that have the same lighter shading as device 704 are devices that are of normal size and color but not brightness, i.e., they are defective only because they are not as bright as they should be. The devices that have the same darker shading as devices 706 and 708 are devices that are of normal size and color but are brighter than they should be. The devices that have the same pattern fill as devices 710 are devices that are of normal size and brightness but not color, e.g., they emit green light rather than blue light. In addition, the devices that have the same pattern fill as devices 712 are of normal size but not color or brightness, e.g., they emit green light rather than blue light and are brighter than they should be.

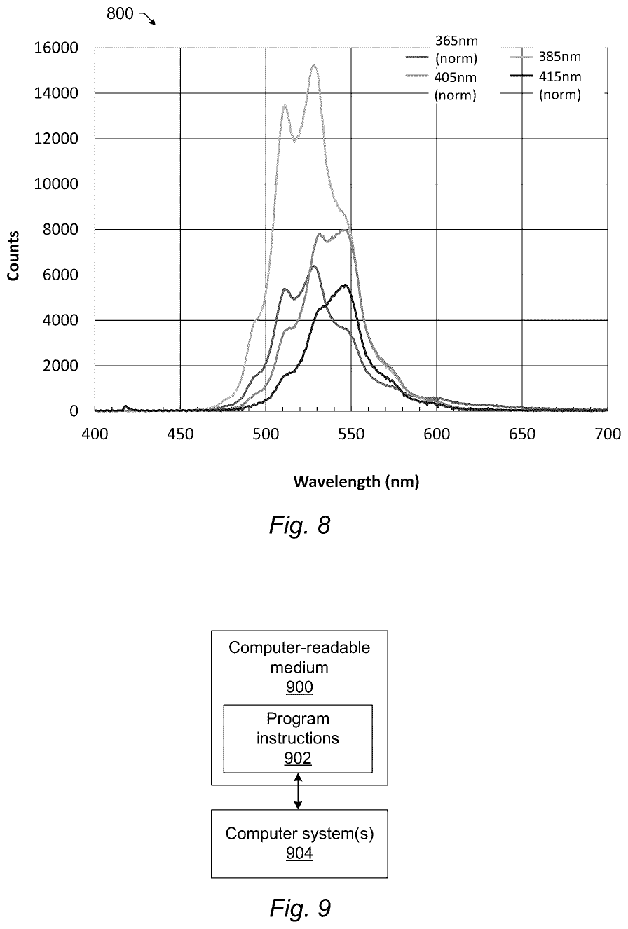

The above-described functionality of electro-optically active devices may also be examined at more than one illumination wavelength band or wavelength. For example, FIG. 8 is a plot of PL emission spectra under different excitation wavelengths, including 365 nm (at a normal angle of incidence), 385 nm, 405 nm (at a normal angle of incidence), and 415 nm (at a normal angle of incidence). The PL emission spectra may be normalized to the incident photon numbers of the illumination light to make comparing and contrasting the emission spectra more accurate. As can be seen in plot 800, the same electro-optically active device may produce different PL emission spectra when illuminated with different excitation wavelengths. Each (or one or more) of these PL emission spectra may be generated by the embodiments described herein and used to determine information for the electro-optically active devices such as functionality, detected defects, characteristics of the defects, etc. In addition, such PL emission spectra indicate how the flexibility of the optics of the embodiments described herein can be useful for not only detecting multiple PL emission spectra from the same device, but also for selecting from the various optics setups and configurations described herein to determine as much or as little information as desired for any one device.

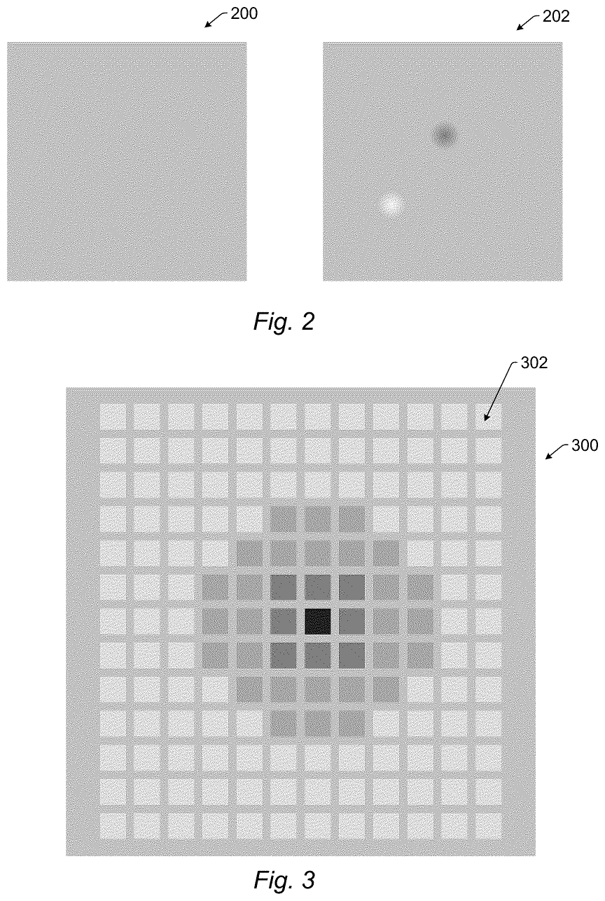

In another such embodiment, determining the information also includes identifying one or more of the electro-optically active devices that are anomalous based on the characteristic of the functionality. For example, one new feature of the embodiments described herein is that the systems can use PL emission to identify anomalous individual electro-optical devices or areas of the wafer containing anomalous devices. FIG. 2 shows an example of an image of a micro-LED wafer showing anomalous regions. In particular, image 200 is a standard (i.e., non-PL) BF image of a micro-LED wafer that shows no features. In contrast, PL image 202 clearly shows anomalous regions of lesser or greater emission than acceptable.

Image 300 in FIG. 3 is an image generated by zooming in on one of the anomalous regions shown in image 202. Each of the squares in this image may be individual micro-LEDs. As shown in image 300, when the computer subsystem zooms in on an anomalous region in the PL image, the computer subsystem may determine that the anomalous region actually corresponds to multiple devices on the wafer. In this manner, the computer subsystem may take certain pixels in the images of the specimen and then expand them to make the details more clear, which can be useful for determining which pixels are actually emitting light.

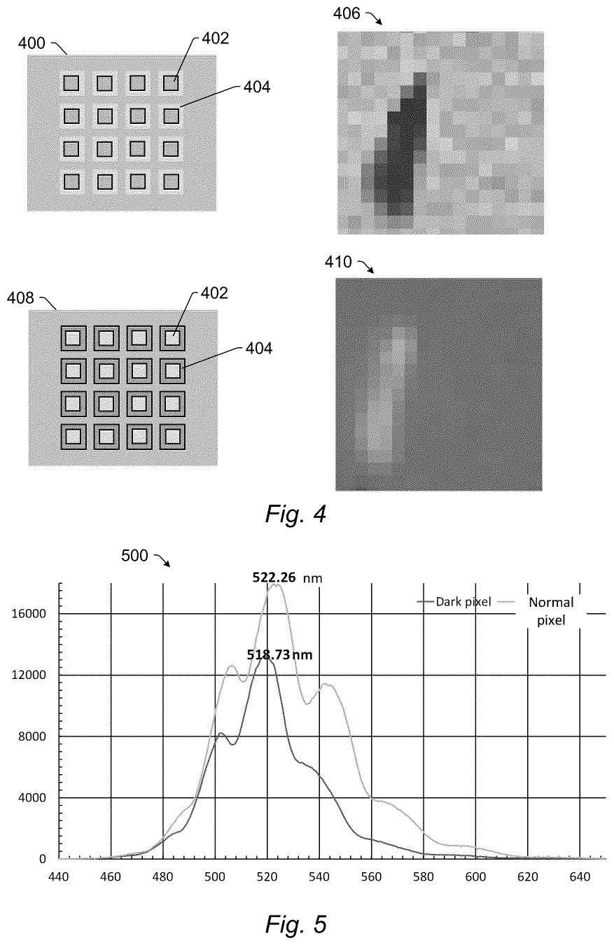

FIG. 4 shows how the computer subsystem may generate composite images from portions of multiple devices to enhance anomalous regions thereby making the anomalous regions easier to detect and analyze. For example, the computer subsystem may generate composite image 406 using only those pixels in raw image 400 that are near the center of each device (active area 402 but not edge area 404) and assigns the average to that device. Each pixel in the composite image represents one device. The darker region is clearly visible. In another example, the computer subsystem may generate composite image 410 using only those pixels in raw image 408 that are near the edge of each device (edge area 404 but not active area 402) and assigns the average to that device. Each pixel in composite image 410 also represents one device, and the brighter region is clearly visible. In this manner, the computer subsystem may analyze the functionality of different portions of the devices described herein in addition to how the functionality varies from device-to-device or from region-to-region on a specimen.

In some such embodiments, the electro-optically active devices are unfinished devices incapable of being electrically tested. For example, one significant advantage of the embodiments described herein is that they provide PL capability that can be used to detect subtle material changes between devices or across the wafer that affect the PL-emitted light. These changes may indicate local defects or process variation that otherwise might not be detected until electrical test once the wafer is completely processed. By detecting these deviations early, users can take corrective action quickly and save time and money. In addition, the embodiments described herein can use PL to sort or screen every micro-LED on a wafer at a production worthy throughput before they are mass-transferred to a final display device at which point they can be electrically probed.

In one embodiment, the specimen includes one or more packaging structures formed thereon, and the PL includes PL emitted by the one or more packaging structures. One important new feature of the embodiments described herein is therefore that they provide systems configured for exciting and analyzing PL (or fluorescence) emission of advanced packaging devices in general. Recent years have seen the acceleration of advanced packaging techniques which make mass-production of complex mobile devices and high-performance computing processors feasible. As these devices are produced, they need to be inspected. Therefore, the inspection of advanced packaging structures is a growing and important application area. The embodiments described herein provide significant advantages for such applications because they can provide all the advantages described herein for inspecting these packaging structures.

In one such embodiment, determining the information includes determining if any of the one or more packaging structures are anomalous based on the detected PL. For example, one new feature of the embodiments described herein is that the systems can use PL emission to identify anomalous advanced packaging devices or areas of the wafer containing anomalous devices. For example, some advanced semiconductor packaging materials such as PI and PBO emit fluorescence while metals do not. Therefore, it is possible to use PL inspection to enhance the capture rate of certain hard-to-find defects. In the embodiments described herein, the system may be configured for illumination wavelengths that can cause fluorescence from such materials and for selectively detecting fluorescence from the illuminated specimen having such advanced packaging structures formed thereon. The computer subsystem may then detect defects on the specimen based on the output responsive to the fluorescence. For example, the detected fluorescence may be used to determine information for the structures and/or materials that fluoresce such as location, size, shape, etc. The computer subsystem may then apply a defect detection method to that information, e.g., applying a threshold to the size of the fluorescing structures to determine if the fluorescing structures are large enough to be considered a defect. Instead of applying a defect detection method to information determined from fluorescent responsive output, the defect detection method may be applied to the fluorescent output itself. Such defect detection may include applying one or more thresholds to a characteristic of the fluorescent responsive output, which may include any of the PL responsive output characteristics described further herein.

In another embodiment, determining the information includes determining metrological information for one or more structures formed on the specimen based on the output generated by the detection subsystem responsive to the detected PL. For example, the computer subsystem may be configured for analyzing the PL responsive output and extracting critical dimension (CD) information from the images. CD information includes, but is not limited to: (1) micro-LED light extraction window size and shape; (2) micro-LED mesa size and shape; (3) micro-LED pitch; (4) RDL width and pitch; (5) via dimension; (6) photoresist opening dimension; and (7) overlay. The computer subsystem may be configured to determine such metrological information for the specimen using any suitable methods and/or algorithms known in the art.

In a further embodiment, the illumination subsystem, detection subsystem, and computer subsystem are configured for simultaneously determining the information and performing non-PL inspection of the specimen. “Non-PL inspection” as that term is used herein is defined as inspection performed by detecting light from a specimen having the same wavelength(s) as the illumination wavelength(s) and detecting defects on the specimen based on output responsive to the detected light. For example, the system may be configured for performing any of the above PL-related functions simultaneously with traditional optical inspection. The system may be configured for performing the non-PL or traditional inspection of the specimen in any suitable manner known in the art.

In one such case, light from a specimen having the same wavelength(s) as illumination and PL from the specimen may be separately detected as described further herein. The computer subsystem may be configured for separately using the different output to determine information for the specimen. For example, the computer subsystem may apply a first defect detection algorithm to the PL responsive output and may apply a second defect detection algorithm to the non-PL responsive output. The first and second defect detection algorithms may be the same or different in any one or more parameters, and the computer subsystem may apply the first and second defect detection algorithms to the different output simultaneously or at different times.

Determining the information by PL and non-PL inspection may in some instances be performed using the same method or algorithm (e.g., as when one defect detection method can be used to detect defects on the specimen with both PL responsive output and non-PL responsive output). However, in many cases, because the information being determined with PL and non-PL will more likely than not be different, even if that means simply detecting different types of defects on the specimen with PL and non-PL output, the computer subsystem may use different methods or algorithms for determining information with the PL and the non-PL responsive signals.

The computer subsystem may also be configured for simultaneously processing the images (PL and/or non-PL) in more traditional ways to detect traditional optical inspection defects such as bridges, opens, residue, over-etch, under-etch, fall-on particles, etc. Thus, the PL capability may be an add-on feature that can be enabled or not, depending on the application, and does not negatively impact throughput or sensitivity if it is not used.

The different inspections may typically be performed to detect different kinds of defects on the same specimen, but in some cases, the different inspections may be performed to detect the same kind of defect on the specimen. For example, the traditional defect inspection may be used to detect as many defects on the specimen as possible, which may include some defects that do not emit PL under any circumstances and some defects that might. PL inspection may also be performed on the specimen (possibly simultaneously as described herein) for a number of reasons including detecting defects on the specimen that emit PL and that might be missed by traditional inspection and/or for separating the detected defects into those that emit PL and those that do not. In this manner, the results of PL inspection performed in combination with traditional inspection may be used as a kind of additional defect attribute that can be used to separate different defect types from each other. The same can be true for traditional inspection defect attributes that are used as a supplement to PL-based defect attributes. In this manner, PL inspection and non-PL inspection can be used as different modes in an inspection process, which may be performed in the same manner as any other multi-mode inspection process currently performed.

In the same manner, the systems described herein may be configured for performing inspection with PL while also performing traditional metrology or vice versa. In some cases, performing inspection and metrology at the same time may not make sense because of the different measurement times typically needed for such processes, but if the metrology can be performed substantially quickly, e.g., at the same or roughly the same throughput as inspection, such a system configuration becomes more practical. Another possibility is performing PL metrology while also performing non-PL metrology on the same specimen simultaneously or otherwise. For example, it may make sense to determine a first metrological characteristic of a patterned feature on a specimen with non-PL metrology and a second metrological characteristic of the same feature with PL metrology. In another example, the system may be configured to determine a metrological characteristic of a first patterned feature on a specimen with non-PL metrology and a metrological characteristic of a second patterned feature on the specimen with PL metrology. In a further example, the system may be configured to determine the same metrological characteristic of a patterned feature on a specimen using a combination of PL and non-PL responsive output. In this manner, due to the flexibility of the systems described herein, the embodiments described herein may provide the ability to determine more metrological information for a specimen that may be better (e.g., more accurate, more detailed, etc.) than currently available metrology tools.

The computer subsystem may be configured for generating results for the specimen, which may include any of the information described herein such as information about any of the devices determined to be defective, any of the defect or metrological information described herein, a map of defect or metrological information across the specimen, etc. The results for the defective devices may include, but are not limited to, locations of the defective devices, detection scores, information about the defective device classifications such as class labels or IDs, etc., or any such suitable information known in the art. The results for the specimen may be generated by the computer subsystem in any suitable manner.

All of the embodiments described herein may be configured for storing results of one or more steps of the embodiments in a computer-readable storage medium. The results may include any of the results described herein and may be stored in any manner known in the art. The results for the specimen may have any suitable form or format such as a standard file type. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. to perform one or more functions for the specimen or another specimen of the same type.

Such functions include, but are not limited to, altering a process such as a fabrication process or step that was or will be performed on the specimen in a feedback or feedforward manner, etc. For example, the computer subsystem may be configured to determine one or more changes to a process that was performed on the specimen and/or a process that will be performed on the specimen based on the defective devices. The changes to the process may include any suitable changes to one or more parameters of the process. The computer subsystem preferably determines those changes such that the defective devices can be reduced or prevented on other specimens on which the revised process is performed, the defective devices can be corrected or eliminated on the specimen in another process performed on the specimen, the defective devices can be compensated for in another process performed on the specimen, etc. The computer subsystem may determine such changes in any suitable manner known in the art.

Those changes can then be sent to a semiconductor fabrication system (not shown) or a storage medium (not shown) accessible to both the computer subsystem and the semiconductor fabrication system. The semiconductor fabrication system may or may not be part of the system embodiments described herein. For example, the imaging hardware and/or the computer subsystem described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

Each of the embodiments of each of the systems described above may be combined together into one single embodiment.

Another embodiment relates to a method for determining information for a specimen. The method includes directing light having one or more illumination wavelengths to a specimen, e.g., with an illumination subsystem configured as described herein. The method also includes detecting PL from the specimen, e.g., with a detection subsystem configured as described herein. In addition, the method includes determining information for the specimen from output responsive to the detected PL, e.g., with a computer subsystem configured as described herein.

Each of the steps of the method may be performed as described further herein. The method may also include any other step(s) that can be performed by the system, computer subsystem, and/or illumination and detection subsystems described herein. The computer subsystem, the illumination subsystem, and the detection subsystem may be configured according to any of the embodiments described herein, e.g., computer subsystem 46, an illumination subsystem shown in FIG. 1, and a detection subsystem shown in FIG. 1, respectively. In addition, the method described above may be performed by any of the system embodiments described herein.

An additional embodiment relates to a non-transitory computer-readable medium storing program instructions executable on one or more computer systems for performing a computer-implemented method for determining information for a specimen. One such embodiment is shown in FIG. 9. In particular, as shown in FIG. 9, non-transitory computer-readable medium 900 includes program instructions 902 executable on computer system(s) 904. The computer-implemented method may include any step(s) of any method(s) described herein.

Program instructions 902 implementing methods such as those described herein may be stored on computer-readable medium 900. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system(s) 904 may be configured according to any of the embodiments described herein.

Further modifications and alternative embodiments of various aspects of the invention will be apparent to those skilled in the art in view of this description. For example, methods and systems for determining information for a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured for determining information for a specimen, comprising:
an illumination subsystem configured for directing light having one or more illumination wavelengths to a specimen;
a detection subsystem configured for detecting photoluminescence from the specimen; and
a computer subsystem configured for determining information for the specimen from output generated by the detection subsystem responsive to the detected photoluminescence.

2. The system of claim 1, wherein the one or more illumination wavelengths comprise red, green, and blue wavelengths.

3. The system of claim 1, wherein the one or more illumination wavelengths comprise red, green, blue, and ultraviolet wavelengths.

4. The system of claim 1, wherein the specimen comprises electro-optically active devices, and wherein the one or more illumination wavelengths are selected to be absorbable by the electro-optically active devices thereby causing the electro-optically active devices to emit the photoluminescence.

5. The system of claim 4, wherein determining the information comprises determining a characteristic of functionality of the electro-optically active devices.

6. The system of claim 5, wherein determining the information further comprises identifying one or more of the electro-optically active devices that are anomalous based on the characteristic of the functionality.

7. The system of claim 4, wherein the electro-optically active devices are unfinished devices incapable of being electrically tested.

8. The system of claim 4, wherein the electro-optically active devices comprise micro-light emitting diodes, and wherein the photoluminescence comprises photoluminescence emitted by the micro-light emitting diodes.

9. The system of claim 1, wherein the photoluminescence does not comprise fluorescence. The system of claim 1, wherein the photoluminescence comprises fluorescence.

11. The system of claim 1, wherein the specimen comprises one or more packaging structures formed thereon, and wherein the photoluminescence comprises photoluminescence emitted by the one or more packaging structures.

12. The system of claim 11, wherein determining the information comprises determining if any of the one or more packaging structures are anomalous based on the detected photoluminescence.

13. The system of claim 1, wherein the illumination and detection subsystems are further configured for both brightfield and darkfield imaging, and wherein the computer subsystem is further configured for selecting only the brightfield imaging, only the darkfield imaging, or both the brightfield and darkfield imaging for determining the information based on one or more characteristics of the specimen.

14. The system of claim 1, wherein the illumination subsystem is further configured for directing light having multiple illumination bands to the specimen, wherein the detection subsystem is further configured for detecting light having multiple detection bands from the specimen, and wherein the computer subsystem is further configured for selecting one or more of the multiple illumination bands and one or more of the multiple detection bands used for determining the information based on one or more characteristics of the specimen.

15. The system of claim 1, wherein determining the information comprises detecting defects on the specimen based on the output generated by the detection subsystem responsive to the detected photoluminescence.

16. The system of claim 1, wherein determining the information comprises determining metrological information for one or more structures formed on the specimen based on the output generated by the detection subsystem responsive to the detected photoluminescence.

17. The system of claim 1, further comprising a scanning subsystem configured for causing the light from the illumination subsystem to be scanned over the specimen while the photoluminescence is detected from the specimen at an inline inspection throughput.

18. The system of claim 1, wherein the illumination subsystem, detection subsystem, and computer subsystem are further configured for simultaneously determining the information and performing non-photoluminescent inspection of the specimen.

19. The system of claim 1, wherein the detection subsystem comprises a long-pass filter positioned in front of a detector configured for detecting the photoluminescence.

20. A method for determining information for a specimen, comprising:
directing light having one or more illumination wavelengths to a specimen;
detecting photoluminescence from the specimen; and
determining information for the specimen from output responsive to the detected photoluminescence.
